(19) United States
(12) Patent Application Publication
(10) Pub. No.: US 2026/0042483 A1
(43) Pub. Date: Feb. 12, 2026

(54) METHOD OF CONTROLLING VEHICLE AND VEHICLE IMPLEMENTING THE SAME

(71) Applicants: Hyundai Motor Company, Seoul (KR); Kia Corporation, Seoul (KR)

(72) Inventor: Chan II PARK, Hwaseong-si (KR)

(73) Assignees: Hyundai Motor Company, Seoul (KR); Kia Corporation, Seoul (KR)

(21) Appl. No.: 19/296,090

(22) Filed: Aug. 11, 2025

(30) Foreign Application Priority Data
Oct. 8, 2024 (KR) 10-2024-0137006

(51) Int. Cl. B62D 15/02; B62D 6/00

(52) U.S. Cl. CPC B62D 15/025; B62D 6/003; B62D 15/029

(57) ABSTRACT

A vehicle includes a steering device; a travel information means obtaining travel information of a vehicle; a road information means obtaining road information on a travel road of the vehicle; and a controller controlling the steering device based on the travel information and the road information, wherein the controller is configured to determine a steering angle limit depending on a curvature change of the road, and performs automated steering control based on the steering angle limit.

### CROSS-REFERENCE TO RELATED APPLICATION

The present application claims priority to Korean Patent Application No. 10-2024-0137006, filed on Oct. 8, 2024, the entire contents of which is incorporated herein for all purposes by this reference.

### BACKGROUND OF THE PRESENT DISCLOSURE

### Field of the Present Disclosure

The present disclosure relates to a method for controlling a vehicle and a vehicle implementing the same.

### Description of Related Art

The statements in the present section merely provide background information related to the present disclosure and may not form related art.

In recent years, there is a growing demand for vehicles provided with a system controlling the steering automatically, which is one of advanced driver assistance system (ADAS) technologies.

Automated steering control systems may come with different features in various regions or countries including Europe, North America, South Korea, and the like, but the maximum horizontal acceleration on a curved road is limited by the law.

That is, the automated steering control system of a vehicle in a certain country shall satisfy the maximum horizontal acceleration regulated by the relevant law in the country.

In the case where the maximum horizontal acceleration condition is not satisfied, the automated steering system deactivates the automated steering control and transfers the control authority to the driver.

For example, in a travel situation on a curved road as shown in FIG. 1, a vehicle is configured to set a control path Pc and performs automated travel on the curved road, but at the instant time, its horizontal acceleration determined based on a vehicle speed or a radius of curvature may exceed the limited maximum horizontal acceleration, and the vehicle deactivates the automated steering control to comply with the relevant law.

If the driver does not intervene in the state where the automated steering control is deactivated, the vehicle may travel along a departure path Po as shown in FIG. 1 and depart from the travel lane.

If the automated steering control is often deactivated due to a simple process of the automated steering system in the above-described situation, the driver feels inconvenient since the driver often intervenes, and worries about safety of travel.

The above-described situation may occur in the case where a speed cannot decrease on a curved road due to the limitations of the system.

For example, the above-described situation may occur in the case where a curved road ahead cannot be predicted although the current vehicle speed is high. If information of a map used for automated driving is not sufficient, or a forward road is not recognizable due to limitations of the recognition scope of a camera, and the like, the above situation may occur, for example.

Additionally, the situation may occur in the case where the driver overdrives in an automated steering control situation. In other words, it may occur when the driver does not reduce the speed with the automated control temporarily deactivated due to the driver's overdrive.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to alleviating the deactivated situation of automated steering control on a curved road.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

A vehicle according to an exemplary embodiment of the present disclosure may include a steering device; a travel information means obtaining travel information of the vehicle; a road information means obtaining road information on a road on which the vehicle travels; and a controller controlling the steering device based on the travel information and the road information, wherein the controller is configured to determine a steering angle limit depending on a curvature change of the road, and to perform automated steering control based on the steering angle limit.

In at least an exemplary embodiment of the present disclosure, in a case where the curvature change is greater than or equal to a predetermined value, the controller may be configured to determine the steering angle limit based on a curvature of the road.

In at least an exemplary embodiment of the present disclosure, the controller is configured to determine a curvature of the road based on a control path which is determined for the vehicle to travel along the road.

In at least an exemplary embodiment of the present disclosure, the curvature includes a current curvature of a current position and a forward curvature of a forward position on the control path.

In at least an exemplary embodiment of the present disclosure, the controller is configured to perform the automated steering control based on a required steering angle along the control path and the steering angle limit.

In at least an exemplary embodiment of the present disclosure, in a case where a required steering angle is greater than or equal to the steering angle limit, the controller may limit a steering angle control to the steering angle limit to perform the automated steering control.

In at least an exemplary embodiment of the present disclosure, the controller is configured to limit a steering angle control to the steering angle limit, and then deactivates the automated steering control.

In at least an exemplary embodiment of the present disclosure, the controller may output a predicted path of the vehicle to a display device after the deactivating of the automated steering control.

In at least an exemplary embodiment of the present disclosure, the controller may limit a steering angle control to the steering angle limit, and then determine and output a required deceleration or a required decelerated speed.

In at least an exemplary embodiment of the present disclosure, in a case where a required steering angle is less than the steering angle limit, the controller may be configured to determine a steering angle control to be identical to a value of the required steering angle to perform the automated steering control.

A method for controlling a vehicle according to an exemplary embodiment of the present disclosure may include obtaining, by a travel information means of the vehicle, travel information of the vehicle; obtaining, by a road information means of the vehicle, road information on a road on which the vehicle travels; and controlling, by a controller, a steering device of the vehicle based on the travel information and the road information, wherein the method further includes determining, by the controller, a steering angle limit depending on a curvature change of the road, and performing, by the controller, automated steering control based on the steering angle limit.

In the method according to at least an exemplary embodiment of the present disclosure, the determining of the steering angle limit may include determining a steering angle limit based on a curvature of the road, in a case where the curvature change is greater than or equal to a predetermined value.

In the method according to at least an exemplary embodiment of the present disclosure, the determining of the steering angle limit further includes determining a curvature of the road based on a control path which is determined for the vehicle to travel along the road.

In the method according to at least an exemplary embodiment of the present disclosure, the curvature may include a current curvature of a current position and a forward curvature of a forward position on the control path.

In the method according to at least an exemplary embodiment of the present disclosure, the performing of the automated steering control may include performing the automated steering control based on a required steering angle along a control path and the steering angle limit.

In the method according to at least an exemplary embodiment of the present disclosure, the performing of the automated steering control may include limiting a steering angle control to the steering angle limit to perform the automated steering control, in a case where a required steering angle is greater than or equal to the steering angle limit.

In the method according to at least an exemplary embodiment of the present disclosure, the performing of the automated steering control may include limiting a steering angle control to the steering angle limit, and then deactivating the automated steering control.

In the method according to at least an exemplary embodiment of the present disclosure, the performing of the automated steering control may further include outputting a predicted path of the vehicle to a display device after the deactivating the automated steering control.

In the method according to at least an exemplary embodiment of the present disclosure, the performing of the automated steering control may further include limiting a steering angle control to the steering angle limit, and then determining and outputting a required deceleration or a required decelerated speed.

In the method according to at least an exemplary embodiment of the present disclosure, the performing of the automated steering control may include determining a steering angle control to be identical to a value of a required steering angle to perform the automated steering control in a case where a required steering angle is less than the steering angle limit.

According to an exemplary embodiment of the present disclosure, the occurrence of deactivation of automated steering control on a curved road may decrease.

According to an exemplary embodiment of the present disclosure, the maximum horizontal acceleration may be managed not to be exceeded in a section where the curvature changes dramatically so that a sudden deactivation of the control does not occur.

According to an exemplary embodiment of the present disclosure, the occurrence of unsatisfying a relevant law due to an excessive horizontal acceleration may be alleviated, to make it effective to comply with the law.

According to an exemplary embodiment of the present disclosure, since automated steering control differs in a section where the curvature changes dramatically, the steering control may not be affected in a normal section, i.e., a section where the curvature does not change dramatically so that the set maximum horizontal acceleration does not need to be decreased in consideration of a sudden curvature-change situation, but rather may be increased, ensuring improvement in a product value.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 shows an automated steering control situation on a curved road.

FIG. 2 shows an exemplary embodiment of an automated steering system and a vehicle including the same according to an exemplary embodiment of the present disclosure.

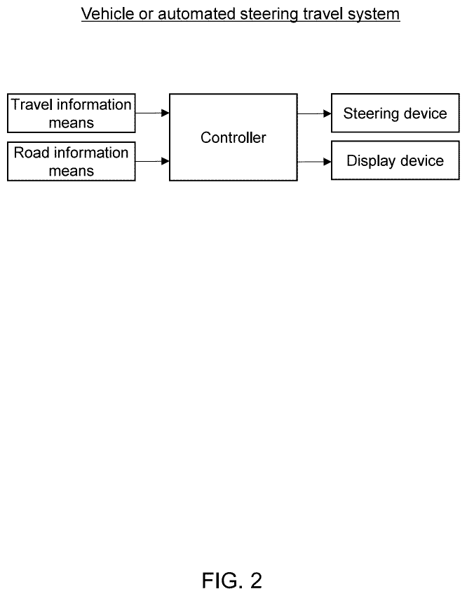

FIG. 3 shows an exemplary embodiment of a process of control according to an exemplary embodiment of the present disclosure.

FIG. 4 shows an exemplary embodiment of a process of control of “A” in FIG. 3.

FIG. 5 shows a travel situation on a curved road according to an exemplary embodiment of the present disclosure.

FIG. 6 shows a display screen according to an exemplary embodiment of the present disclosure.

FIG. 7 shows results of simulation of automated steering control according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, the same reference numerals refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

While example embodiments are described with reference to the accompanying drawings, it can be understood that various changes and modifications may be made in other exemplary embodiments of the present disclosure. Furthermore, it can be understood that the present disclosure is not necessarily limited to the specific example embodiments thereof, and various changes, equivalences, and substitutions may be made without departing from the scopes and spirit of the present disclosure.

In the example embodiments of the present disclosure, terms such as “module”, “unit”, “part”, and the like, may be used for nominal distinct between components, and should not necessarily be interpreted as assuming that they are physically and chemically separated or capable of being separated or divided.

Terms including ordinal numbers, such as “first”, “second”, etc., may be used to describe various components, but such components are not necessarily limited by such terms. Such terms may be used only in a nominal sense to differentiate one component from another component, and their mutual sequential meaning may be understood through the context of the corresponding description.

The term “and/or” can be used to include all instances of any combination of multiple items being the subject. For example, “A and/or B” includes all three cases: “A”, “B”, and “A and B”.

When a component is used to be “coupled” or “connected” to another component, it may be understood that the component may be either directly connected to another component, or connected indirectly via another medium and/or intervening component(s).

Terms in the present application may be used to describe an exemplary embodiment and do not intend to necessarily restrict and/or limit the present disclosure. Singular forms may be intended to include plural forms unless the context clearly indicates otherwise. According to an exemplary embodiment of the present disclosure, terms such as “comprise” or “consist of” are used to designate presence of characteristics, numbers, steps, operations, elements, components, or a combination thereof, and do not foreclose the presence or possibility of addition of one or more other characteristics, numbers, steps, operations, elements, components, or a combination thereof.

Unless otherwise defined, terms used in the present disclosure, including technical or scientific terms, can include a the same meaning as generally understood by an ordinary person skilled in the field of the present disclosure to which the present disclosure pertains. Terms defined in commonly used dictionaries can be interpreted as having a meaning consistent with the meaning in the context of the related technology, and unless clearly defined in the present application, should not be interpreted in an ideal or excessively formal sense.

Furthermore, the terms “unit”, “control unit”, “control device”, or “controller” may be widely used for names of devices that control the corresponding functions, and are not construed as being generic functional units. For example, devices using such terms may include a communication device that communicates with another controller or sensor to control the corresponding function, a computer-readable recording media that stores operating systems, logic commands, input/output information, etc., and at least one of processor that is configured to perform determination, calculation, decision, etc. used to control the corresponding function.

A processor may include a semiconductor integrated circuit and/or electronic elements that perform at least one of comparison, determination, calculation, and decision to achieve a programmed function. For example, a processor may be one or the combination of a computer, a microprocessor, a CPU, an ASIC, and electronic circuits (circuitry, logic circuits).

A computer-readable recording medium (or referred to as memory or storage medium) can include all types of storage devices that store data that is read by a computer system. Examples of the computer-readable recording medium may include a memory of flash memory type, hard disk type, micro type, and card type (e.g., Secure Digital Card (SD Card) or eXtream Digital Card (XD Card)), and a memory of Random Access Memory (RAM), Static RAM (SRAM), Read-Only Memory (ROM), Programmable ROM (PROM), Electrically Erasable PROM (EEPROM), and magnetic RAM (MRAM), a magnetic disk, or an optical disk type, or any combination thereof.

The recording medium may be electrically connected to the processor, and the processor may load and record data from the recording medium. The recording medium and the processor may be integrated or physically separated.

Hereinafter, various exemplary embodiments of the present disclosure are specifically described with reference to the accompanying drawings.

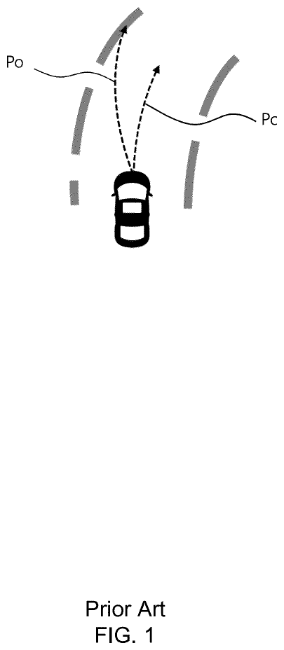

As shown in FIG. 1, an automated steering system or a vehicle according to an exemplary embodiment includes a controller, a travel information means, a road information means, a steering device, and a display device.

The controller may be configured for controlling the steering device and the display device, based on information obtained by use of the travel information means and the road information means, to perform automated steering control.

The travel information means detects travel information of the vehicle, and may include at least one vehicle speed sensor.

The road information means obtains information on a road where the vehicle is traveling. The road information means may be a memory in which a road information map is stored, or an image obtaining means that can obtain an image of a forward road.

The image obtaining means may be a camera or a Light Detection and Ranging (LiDAR), for example.

The controller, as described above, may include a memory in which a computer-readable program for automated steering control is stored, and a processor that executes the program.

The steering device may include a steering wheel, or an electric power steering (EPS) or a motor driven power steering (MDPS). The steering device may perform steering of the wheels of the vehicle according to a control signal of the controller.

The display device may include an instrument cluster or an Audio Video Navigation (AVN) screen which is provided in the vehicle, and according to a control signal of the controller, output a visual display corresponding to the control signal.

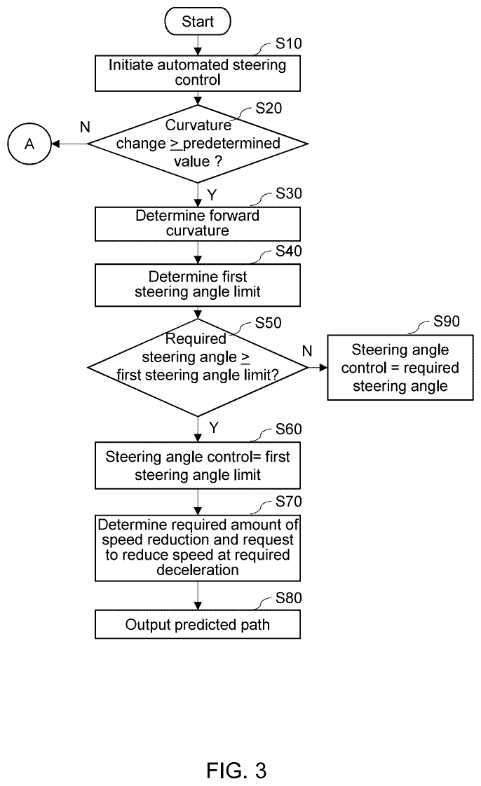

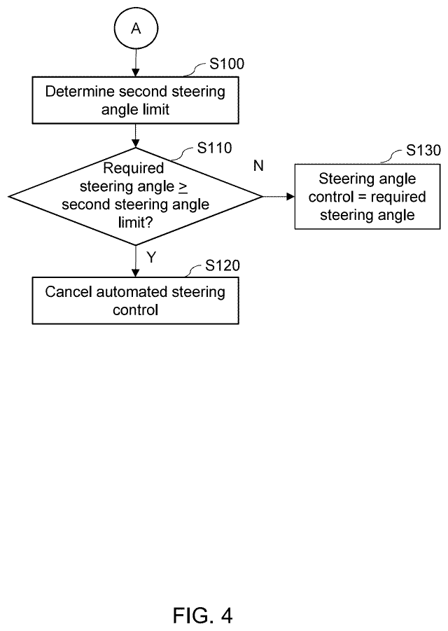

Hereinafter, a process of control according to an exemplary embodiment of the present disclosure is specifically described with reference to FIG. 3 and FIG. 4.

First, the controller is configured to initiate automated steering control in step S10.

The automated steering control may be Highway Driving Assist (HDA) I, HDA II, Highway Driving Pilot (HDP), or any automated control including automated steering control on a curved road among ADAS technologies, for example.

The initiation of the automated steering control may be conducted based on a selection of the driver, but the exemplary embodiment does not limited thereto.

For example, an input button configured to allow the selection of automated steering control is provided in the vehicle so that the automated steering control may be initiated as the driver presses the button.

The controller is configured to check whether a curvature change of the road is a predetermined value or greater or not while the vehicle travels, based on the automated steering control, in step S20.

To the present end, the controller may be configured to determine a curvature change rate of the road, and check whether the change rate is greater than or equal to a predetermined change rate, for example.

At the present time, when it is determined that the condition is satisfied in step S20 (Y in S20), the controller is configured to determine a forward curvature in step S30.

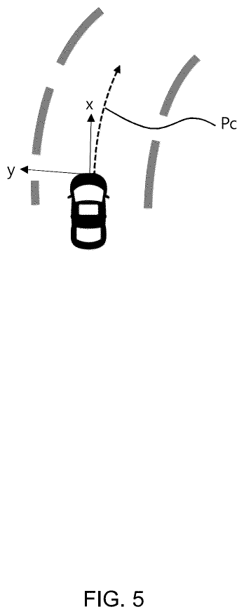

The controller may be configured to determine a control path Pc, as shown in FIG. 5, by use of a cubic equation shown in Math Formula 1, to perform the automated steering control on a curved section of the road, and use the control path Pc to determine a curvature of the road at a current position (hereinafter, “current curvature”) and a curvature of a predetermined forward position determined as a control target point (hereinafter, “forward curvature”).

$$y ( x ) = {ax}^{3} + {bx}^{2} + cx + d \qquad [ Math Formula 1 ]$$

Referring to FIG. 5, in Math Formula 1, x denotes a travel direction (a longitudinal direction) of the vehicle, y denotes a horizontal direction thereof, and a, b, c, and d are parameters of the control path Pc.

That is, second order differentiation is performed to the equation of Math Formula 1 above, and then the current curvature Ccur may be determined by Math Formula 2, and the forward curvature Cpred may be determined by Math Formula 3.

$${C}_{cur} = 2 b \qquad [ Math Formula 2 ]$$

$${C}_{pred} = 6 ax + 2 b = 6 {aV}_{x} t + 2 b \qquad [ Math Formula 3 ]$$

Herein, Vx denotes a speed of the vehicle in the longitudinal direction, and t denotes time.

In Math Formula 3, the time t may be determined by use of a predetermined time value td and a tuning parameter α. That is, the time t may be determined by Math Formula 4.

$$t = {t}_{d} + α \qquad [ Math Formula 4 ]$$

The tuning parameter α may be 0 (zero) as a default value, but adjusted depending on a curvature change rate and a speed.

After the current curvature and the forward curvature are determined, the controller may be configured to determine a first steering angle limit, based on the current curvature and the forward curvature, in step S40.

Herein, the first steering angle limit may be determined by Math Formula 5.

$${δ}_{Max} = ( \frac{L}{{V}_{x}^{2}} + {K}_{v} ) {A}_{yMax} \frac{2 b}{6 {aV}_{x} t + 2 b} \qquad [ Math Formula 5 ]$$

Herein, δ_{Max} denotes the first steering angle limit, Kv is a predetermined value as an understeer coefficient, A_{yMax} is determined as a maximum horizontal acceleration in accordance with the law, and L denotes a distance between a left wheel and a right wheel of the vehicle.

After the first steering angle limit is determined, the controller is configured to compare a required steering angle and the first steering angle limit in step S50.

Herein, the required steering angle may be determined based on a steering angle which is required for the vehicle to travel along the control path Pc.

When it is determined that the required steering angle is greater than or equal to the first steering angle limit in step S50, the controller is configured to perform step S60, and if not, performs step S90.

In step S60, the controller is configured to limit a steering angle (hereinafter, “controlling steering angle”), which is to be applied to control the travel of the vehicle, to the first steering angle limit, to control the steering of the vehicle.

Through the control in step S60, the vehicle can ensure it does not exceed the predetermined maximum horizontal acceleration.

At the present time, the controller may cancel, i.e., deactivate the automated steering control.

In the state where the automated steering control is canceled, the controller may provide a notification by use of the display device to transfer the control authority to the driver.

Even when the automated steering control is canceled, coasting travel may proceed without exceeding the maximum horizontal acceleration and with the steering angle control set to the first steering angle limit, and the driver may attempt to intervene in the driving upon being alerted by the notification described above.

Furthermore, after limiting the steering angle control to the first steering angle limit to steer the vehicle, the controller may, in step S70, determine a required amount of reduction in speed and request to reduce the speed at a required deceleration.

Herein, the required amount of the speed reduction may be determined by Math Formula 6.

$${V}_{diff} = {V}_{mes} - {V}_{Max} \qquad [ Math Formula 6 ]$$

$${V}_{Max} = \sqrt{\frac{{A}_{yMax}}{{C}_{pred}}}$$

Herein, Vmes denotes a current speed in the longitudinal direction of the vehicle.

Additionally, the required deceleration A_{Max} may be determined by Math Formula 7.

$${A}_{Max} = Max ( {A}_{yMax} , α ( {V}_{diff} ) ) \qquad [ Math Formula 7 ]$$

Herein, α(V_{diff}) is a control parameter which is set to change V_{diff} to a value of an acceleration.

The above-described request of the required amount of the speed reduction and the required deceleration may be displayed for the driver on the display device, and delivered to a brake device to enable a deceleration of the vehicle automatically.

Furthermore, after limiting the steering angle control to the first steering angle limit to steer the vehicle, the controller may output a predicted path Pe of the vehicle in step S80.

The predicted path Pe may be determined by Math Formula 8 hereinafter.

$${y}_{e} = \frac{{A}_{yMax}}{{V}_{x}^{2}} {x}^{2} \qquad [ Math Formula 8 ]$$

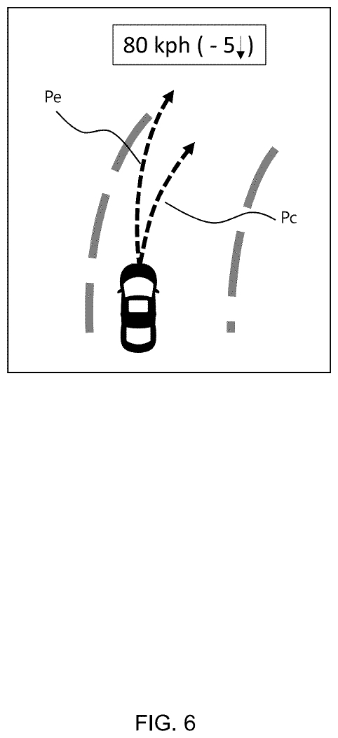

FIG. 6 illustrates an exemplary output of the required amount of a speed reduction and a predicted path Pe through the screen of the display device, which may be the screen of the instrument cluster or the AVN.

On the other hand, when it is determined that the required steering angle is less than the first steering angle limit in step S50, the controller is configured to determine the steering angle control based on the required steering angle to control a curved travel along the control path Pc.

Furthermore, when it is determined that a curvature change is less than the predetermined value in step S20, the controller proceeds with normal section control shown in FIG. 5, which is detailed hereinafter.

The controller is configured to determine a second steering angle limit in step S100.

Unlike the first steering angle limit, the second steering angle limit may be determined by use of a current vehicle speed without considering the forward curvature, as shown in Math Formula 9.

$${δ}_{Max} = ( \frac{L}{{V}_{x}^{2}} + {K}_{v} ) {A}_{yMax} \qquad [ Math Formula 9 ]$$

After the second steering angle limit being determined, the controller is configured to compare the second steering angle limit with the required steering angle in step S110.

When it is determined that the required steering angle is greater than and equal to the second steering angle limit, the controller may cancel the automated steering control in step S120.

On the other hand, when it is determined that the required steering angle is less than the second steering angle limit, the controller may be configured to determine the based on the required steering angle and proceed with automated steering in step S130.

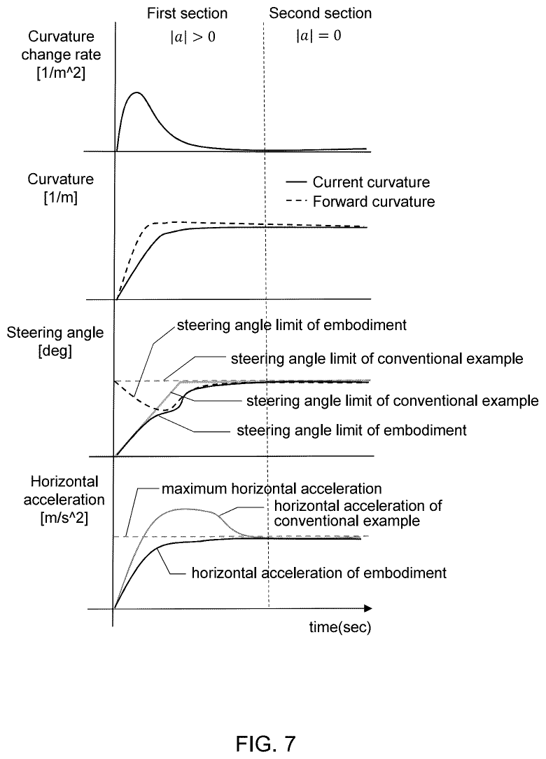

FIG. 7 illustrates results of simulation of automated steering control according to an exemplary embodiment for a conceptual presumptive example of a curved road, which is detailed hereinafter.

As shown in the uppermost graph of FIG. 7, a first section and a second section may be divided depending on a curvature of the road or a curvature change rate of the control path Pc.

Herein, the first section may be a section in which a curvature changes dramatically, and the second section may be a normal section in which a curvature does not do so.

The second graph of FIG. 7 shows the current curvature and the forward curvature.

In the above-described curvature situation, a steering angle limit may be determined as a straight line according to a conventional automated steering system, as shown in the third graph of FIG. 7, but a steering angle limit according to the exemplary embodiment of the present disclosure, i.e., the first steering angle limit, decreases in the first section as shown in the graph. Furthermore, unlike the according to the conventional automated steering system, the steering angle control according to the exemplary embodiment of the present disclosure is determined to be a relatively reduced value, as illustrated.

Furthermore, the horizontal acceleration of the vehicle according to the conventional automated steering system exceeds a predetermined maximum horizontal acceleration, as shown in the lowermost graph of FIG. 7, but the horizontal acceleration according to the exemplary embodiment of the present disclosure may be controlled to be a maximum horizontal acceleration or less even in the first section.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like. Furthermore, the computer-readable recording medium may be distributed over computer systems connected through a network, and computer-readable program code may be stored and executed in a distributive manner.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the embodiments are used for describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle, comprising:
a steering device;
a travel information means obtaining travel information of the vehicle;
a road information means obtaining road information on a road on which the vehicle travels; and
a controller controlling the steering device based on the travel information and the road information,
wherein the controller is configured to determine a steering angle limit depending on a curvature change of the road, and to perform automated steering control based on the steering angle limit.

2. The vehicle of claim 1, wherein based on that the curvature change is greater than or equal to a predetermined value, the controller is further configured to determine the steering angle limit based on a curvature of the road.

3. The vehicle of claim 1, wherein the controller is further configured to determine a curvature of the road based on a control path which is determined for the vehicle to travel along the road.

4. The vehicle of claim 3, wherein the curvature includes a current curvature of a current position and a forward curvature of a forward position on the control path.

5. The vehicle of claim 1, wherein the controller is further configured to perform the automated steering control based on a required steering angle along a control path and the steering angle limit.

6. The vehicle of claim 1, wherein based on that a required steering angle is greater than or equal to the steering angle limit, the controller is further configured to limit a steering angle control to the steering angle limit to perform the automated steering control.

7. The vehicle of claim 1, wherein the controller is further configured to limit a steering angle control to the steering angle limit, and then deactivates the automated steering control.

8. The vehicle of claim 7, wherein the controller is further configured to output a predicted path of the vehicle to a display device after the deactivating of the automated steering control.

9. The vehicle of claim 1, wherein the controller is further configured to limit a steering angle control to the steering angle limit, and then to determine and output a required deceleration or a required decelerated speed.

10. The vehicle of claim 1, wherein based on that a required steering angle is less than the steering angle limit, the controller is further configured to determine a steering angle control to be identical to a value of the required steering angle to perform the automated steering control.

11. A method for controlling a vehicle, the method comprising:
obtaining, by a travel information means of the vehicle, travel information of the vehicle;
obtaining, by a road information means of the vehicle, road information on a road on which the vehicle travels; and
controlling, by a controller, a steering device of the vehicle based on the travel information and the road information,
wherein the method further includes:
determining, by the controller, a steering angle limit depending on a curvature change of the road, and
performing, by the controller, automated steering control based on the steering angle limit.

12. The method of claim 11, wherein the determining of the steering angle limit includes determining the steering angle limit based on a curvature of the road, based on that the curvature change is greater than or equal to a predetermined value.

13. The method of claim 11, wherein the determining of the steering angle limit further includes determining a curvature of the road based on a control path which is determined for the vehicle to travel along the road.

14. The method of claim 13, wherein the curvature includes a current curvature of a current position and a forward curvature of a forward position on the control path.

15. The method of claim 11, wherein the performing of the automated steering control includes performing the automated steering control based on a required steering angle along a control path and the steering angle limit.

16. The method of claim 11, wherein the performing of the automated steering control includes limiting a steering angle control to the steering angle limit to perform the automated steering control, based on that a required steering angle is greater than or equal to the steering angle limit.

17. The method of claim 11, wherein the performing of the automated steering control includes limiting a steering angle control to the steering angle limit, and then deactivating the automated steering control.

18. The method of claim 17, wherein the performing of the automated steering control further includes outputting a predicted path of the vehicle to a display device after the deactivating of the automated steering control.

19. The method of claim 11, wherein the performing of the automated steering control includes limiting a steering angle control to the steering angle limit, and then determining and outputting a required deceleration or a required decelerated speed.

20. The method of claim 11, wherein the performing of the automated steering control includes determining a steering angle control to be identical to a value of a required steering angle to perform the automated steering control based on that a required steering angle is less than the steering angle limit.
